(19) United States
(12) Patent Application Publication
(10) Pub. No.: US 2013/0197797 A1
(43) Pub. Date: Aug. 1, 2013

(54) SYSTEMS AND METHODS FOR ROUTE PLANNING

(71) Applicants: Mark S. Boddy, St. Paul, MN (US); Hazel S. Shackleton, Minneapolis, MN (US)

(72) Inventors: Mark S. Boddy, St. Paul, MN (US); Hazel S. Shackleton, Minneapolis, MN (US)

(73) Assignee: ADVENTIUM ENTERPRISES, Minneapolis, MN (US)

(21) Appl. No.: 13/359,935

(22) Filed: Jan. 27, 2012

(51) Int. Cl. G01C 21/34

(52) U.S. Cl. 701/424

(57) ABSTRACT

The present disclosure includes systems and methods for route planning. As an example, a computer implemented method for route planning can include generating a first portion of a planned route between a first location and a second location by assembling a set of previously traversed route segments each corresponding to one or more of a number of previously traversed routes, aggregating the set of previously traversed route segments with a number of route segments determined by a model-based route planning subsystem and corresponding to a second portion of the planned route, and causing the planned route to be provided to a display of a computing device.

### GOVERNMENT RIGHTS

The subject matter of this disclosure was made with government support under Contract Number N1OPC20185 awarded by the Department of Interior. Accordingly, the U.S. Government has certain rights to subject matter disclosed herein.

### BACKGROUND

Various systems exist for assisting individuals with planning a route between a source point (e.g., starting location) and a destination point (e.g., ending location). Many route planning systems allow users to alter routes by “dragging” portions of the routes around via a graphical user interface (GUI), for example. Some navigation systems can provide guidance (e.g., turn by turn) to direct a user along a route (e.g., following existing roads, streets, highways, etc.). Such navigation systems often provide auditory and/or visual information directing users toward their destination and can redirect users toward their destination if they stray from a planned route, for example.

Such route planning and/or navigation systems are often based on modeled maps of an environment and can be referred to as model-based systems and/or map-based systems. Modeling errors associated with maps of such systems can occur due to changes to the environment, for instance. As an example, particular roads may become congested (e.g., due to traffic) or impassible (e.g., due to a blockade, flooding, a bridge being out, etc.). As such, model-based systems can require frequent updating to the model to ensure that accurate models are maintained (e.g., such that safe and/or efficient routes are provided).

Many model-based route planning systems automatically generate a number of routes for a user based on a user-provided source and destination. The automatically generated route(s) are often cost-minimal routes (e.g., routes generated based on cost analysis) based on user preferences (e.g., shortest distance, fastest, fewest turns, no highways, etc.). The system can then automatically generate the cost-minimal route(s) based on one or more of the user preferences.

Route planning systems can be useful for planning various types of routes corresponding to various modes of transport. For instance, route planning systems can be used for planning walking routes, jogging routes, bicycling routes, and/or motorized vehicle routes, among other types of routes and/or combinations thereof

### BRIEF DESCRIPTION OF THE DRAWINGS

FIG. 1 illustrates a system for route planning in accordance with a number of embodiments of the present disclosure.

FIG. 2 illustrates a computing device associated with route planning in accordance with a number of embodiments of the present disclosure.

FIG. 3 illustrates a functional flow diagram associated with generating a planned route based on previous execution data in accordance with a number of embodiments of the present disclosure.

FIG. 4 illustrates a functional flow diagram associated with generating a planned route in accordance with a number of embodiments of the present disclosure.

FIG. 5 illustrates a diagram associated with route planning in accordance with a number of embodiments of the present disclosure.

### DETAILED DESCRIPTION

The present disclosure includes systems and methods for route planning. As an example, a computer implemented method for route planning can include generating a first portion of a planned route between a first location and a second location by assembling a set of previously traversed route segments each corresponding to one or more of a number of previously traversed routes, aggregating the set of previously traversed route segments with a number of route segments determined by a model-based route planning subsystem and corresponding to a second portion of the planned route, and causing the planned route to be provided to a display of a computing device.

A number of embodiments can include instructions stored on a computer readable medium and which are executed by a processor to perform methods for route planning as described herein. As one example, instructions stored on a computer readable medium can be executed by a processor to generate a planned route between a first location and a second location, the planned route comprising a number of route segments. The number of route segments can include: a set of previously traversed route segments each corresponding to one or more of a number of previously traversed routes, and a number of model-based route segments aggregated with the set of previously traversed route segments. Instructions stored on a computer readable medium can be executed by a processor to evaluate the planned route based on stored previous execution data corresponding to a number of previously executed traversals of at least one of the number of previously traversed route segments of the set, and stored map data corresponding to at least one of the number of model-based route segments.

As an example, a system for route planning can comprise: a computing device including processor and memory resources and a user interface configured to receive user input corresponding to a source, a destination, and a number of user preferences associated with a route to be planned; a previous execution subsystem including a previous execution database and an assembly module configured to assemble a set of previously traversed route segments stored in the previous execution database and representing at least a first portion of a planned route between the source and destination; a model-based subsystem including a map database and a map-based planning module configured to determine a number of route segments based on information stored in the map database and corresponding to at least a second portion of the planned route; and an aggregation module configured to generate a complete planned route between the source and destination by aggregating one or more previously traversed route segments of the set assembled by the assembly module and representing the at least a first portion of the planned route and one or more of the number of route segments determined by the map-based planning module and corresponding to the at least a second portion of the planned route.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

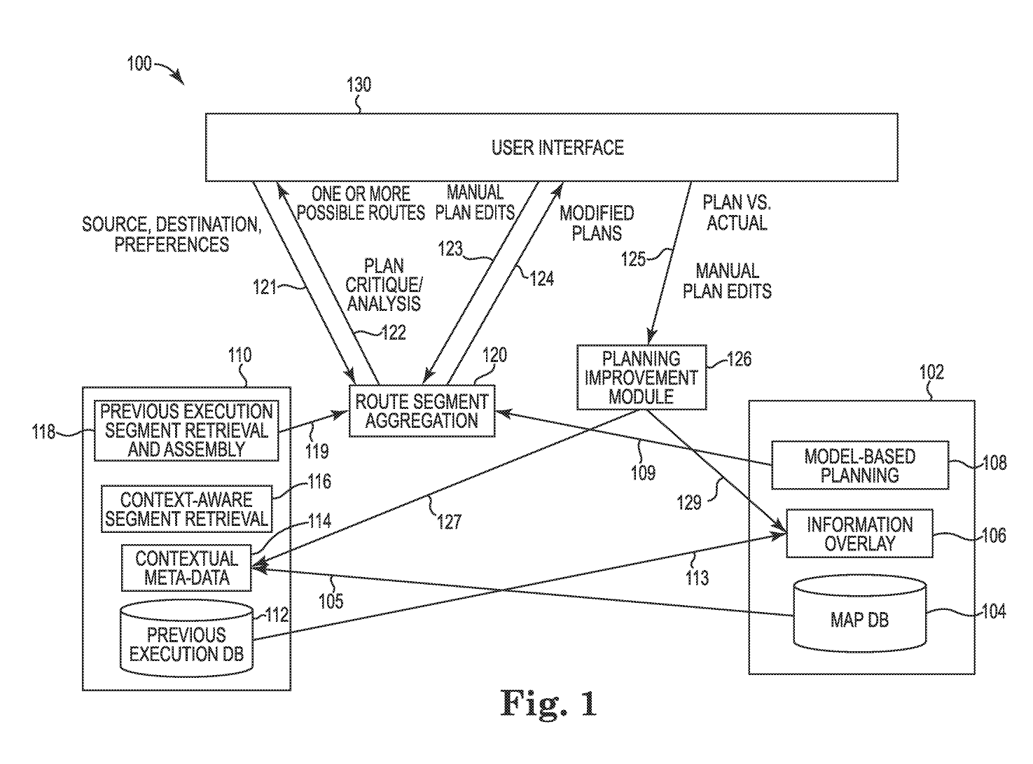

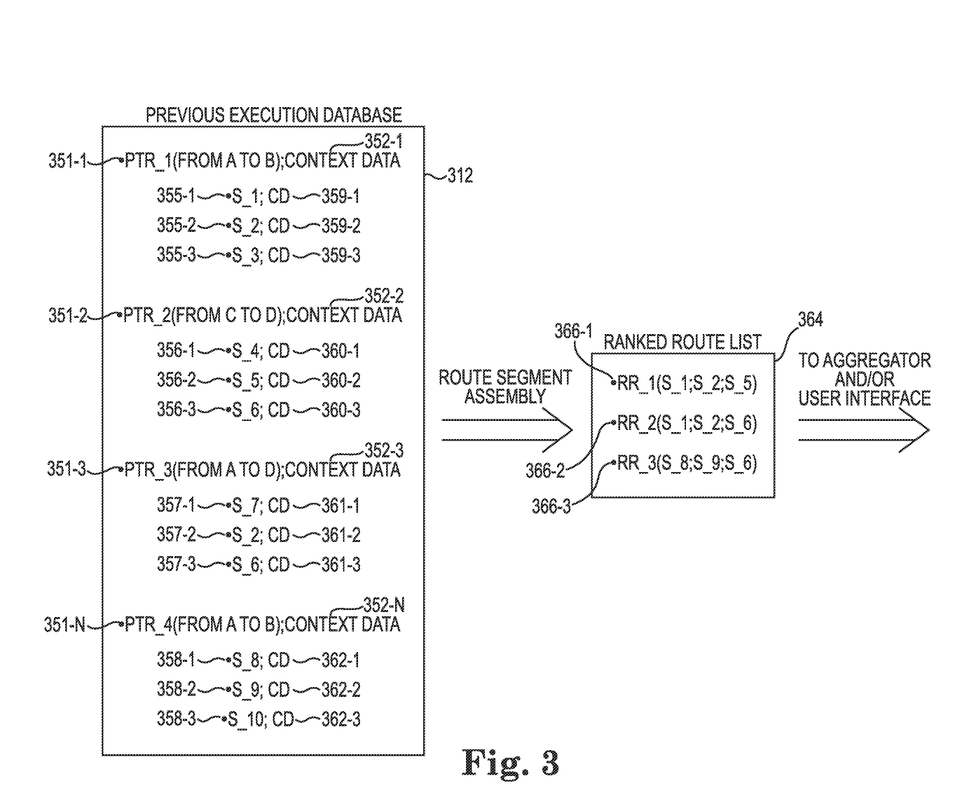

The figures herein follow a numbering convention in which the first digit or digits correspond to the drawing figure number and the remaining digits identify an element or component in the drawing. Similar elements or components between different figures may be identified by the use of similar digits. For example, 112 may reference element “12” in FIG. 1, and a similar element may be referenced as 312 in FIG. 3. As will be appreciated, elements shown in the various embodiments herein can be added, exchanged, and/or eliminated so as to provide a number of additional embodiments of the present disclosure. As used herein, the designators “M” and “N”, particularly with respect to reference numerals in the drawings, indicates that a number of the particular feature so designated can be included. As used herein, “a number of” a particular feature can refer to one or more of such things (e.g., a number of computing devices can refer to one or more computing devices). Various embodiments of the present disclosure can include, and/or can be performed by, sets of computer executable instructions (e.g., software applications, programs, modules, etc.), firmware, and/or hardware, which can be executable and/or resident on systems and/or devices shown herein or otherwise.

FIG. 1 illustrates a system 100 for route planning in accordance with a number of embodiments of the present disclosure. The system 100 includes a model-based route planning subsystem 102 and a previous execution subsystem 110 in communication with a user interface 130. The user interface 130 can be for example, a graphical user interface (GUI) of a computing device such as a handheld mobile device (e.g., a smartphone), laptop computer, or desktop computer, among various other computing devices having processor and memory resources. User interface 130 can allow a user to interact with various subsystems of system 100 in association with planning a route between a first location and a second location (e.g., between a source and a destination), adjusting (e.g., editing, modifying, etc.) a route, and/or executing a planned route, for example. In a number of embodiments, the user interface 130, subsystem 102 and subsystem 110 can be associated with separate physical computing devices. However, embodiments are not so limited. For instance, the user interface 130, subsystem 102, subsystem 110, and/or other subsystems can be associated with a single computing device.

As described further herein, user interface 130 can allow a user to provide system 100 with information such as source and destination information along with user preferences associated with a route from the source to destination. Examples of user preferences include preferences associated with distance (e.g., shortest route), time (e.g., fastest route), simplicity (e.g., fewest turns), congestion (e.g., traffic), concealment level, anti-prediction (e.g., number of times route has been travelled and/or whether route has been travelled recently), mode of transport (e.g., on foot, bicycle, all-terrain vehicle, car, truck, bus, etc.), among various other preferences.

The model-based route planning subsystem 102 can be based on modeled maps of an environment and can employ cost analysis to generate cost-minimal routes based on source, destination, and preference information, for instance. In the example illustrated in FIG. 1, the subsystem 102 includes a map database 104, an information overlay module 106, and a model-based planning module 108 (e.g., executable instructions associated with a model-based planning algorithm). The map database 104 stores geographic information associated with a terrain model. The map database 104 can include information such as topography information and road information (e.g., location and/or vector data), for example. As such, the map database 104 can be associated with a Geographic Information System (GIS) (e.g., a system designed to capture, store, manipulate, manage, analyze, and/or present various types of geographic data).

The information overlay module 106 can include context-specific information (e.g., metadata) associated with the map database 104. For instance, information overlay module 106 can include metadata associated with the locations of construction projects, traversability information based on mode of travel, information concerning degree of concealment, estimated traversal time information, and/or other information associated with map database 104 and which can be used for cost analysis by subsystem 102.

The model-based planning module 108 includes executable instructions associated therewith and which are executable by a processor to generate (e.g., determine) routes, or portions thereof (e.g., route segments), based on information corresponding to map database 104 and information overlay module 106. The planning module 108 can, responsive to information (e.g., source, destination, and user preference information) provided to subsystem 102 via user interface 130, for instance, generate the routes, or portions thereof, based on cost analysis. As described further herein, in various embodiments, subsystem 102 can be employed in conjunction with subsystem 110 to generate planned routes, which can be displayed to a user (e.g., via user interface 130 or otherwise). For instance, as indicated by arrow 109, routes or route segments determined by model-based module 108 can be provided to a route segment aggregation module 120, in various embodiments. In a number of embodiments, and as described further below, the aggregation module 120 is configured to generate a planned route by aggregating a number of route segments determined by a model-based route planning subsystem (e.g., subsystem 102) and an assembled set of previously traversed route segments as determined by a previous execution subsystem (e.g., subsystem 110).

The previous execution subsystem 110 can be used to plan routes based on data corresponding to previous traversals of routes between particular sources and destinations (e.g., previous execution data corresponding to as-executed traversals of a route). In various embodiments, the routes can correspond to previously planned routes between the source and destination. As such, in various embodiments, the subsystem 110 can be used to compare and/or contrast routes as planned with actual traversals (e.g., executions) of those planned routes. For example, in various instances, an individual may stray from a route as planned for various reasons. As described further herein, previous execution data corresponding to previous traversals of a planned route, including differences between the route as planned and the route as executed, can provide useful information that may be used for future route planning, for instance. Such previous execution data can be incorporated into future route planning and analysis without requiring explicit information input from a user, for example. As one example, a previously planned route between source A and destination B may include traversal of a bridge. Previous execution data corresponding to a number of recent actual traversals of the route indicates that various users did not traverse the bridge, but rather went around it in one fashion or another. Such previous execution data can be incorporated into future route planning such that future routes avoid traversal of the bridge. For instance, the bridge may be assumed to be hazardous, inoperable, etc., to account for the purposeful avoidance of it by users. Tracking actual execution of as planned routes including tracking of the context associated with the actual execution can provide valuable information that can be used in future route planning.

In the example illustrated in FIG. 1, the previous execution subsystem 110 includes a previous execution database 112, a contextual metadata module 114, a context-aware segment retrieval module 116, and a previous execution segment retrieval and assembly module 118. The previous execution database 112 can store data corresponding to previously planned routes between sources and destinations as well as previous execution data corresponding to actual traversals of the previously planned routes. As described further herein, the previous execution database 112 can include data corresponding to segments of routes. For example, previous execution data corresponding to previously traversed routes can be segmented based on intersections between previously traversed routes and/or based on divergences between previously traversed routes. The previous execution data stored in database 112 can be acquired in various manners. For instance, data corresponding to previous route execution can be obtained from one or more route planning and/or navigation systems (e.g., MapQuest, Google Maps, Ground Guidance, etc.), which may track route execution via GPS (global positioning system) tracking, for instance.

The contextual metadata module 114 includes contextual metadata corresponding to the previously traversed routes and/or route segments associated with database 112. The contextual metadata can include, for example, data regarding mode of transport, time of day, weather, traversal time, and/or safety concerns, among various other types of contextual metadata associated with a previously traversed route or route segment. In a number of embodiments, the contextual metadata can include previously planned routes (e.g., route plans) associated with previous execution data stored in database 112. Such contextual metadata can be used for various purposes. For instance, the contextual metadata can be considered in association with ranking a number of generated route plans (e.g., according to user preferences. The contextual metadata can also be used in association with evaluating (e.g., critiquing) a route planned by a user. For instance, the contextual metadata can indicate that a user-planned route goes through an extremely crowded area at a particular time (e.g., rush hour). As described further below, in a number of embodiments, a user can be informed of such information (e.g., via a display associated with user interface 130) and provided an opportunity to modify the planned route in response to the same. Although shown as a separate module, the contextual metadata 114 can be included within database 112. Furthermore, the contextual metadata can be appended to the previous execution data on a segment by segment basis.

As indicated by arrows 105 and 113, data can be shared between subsystems 102 and 110. For instance, data stored in map database 104 can be used to update contextual metadata corresponding to module 114, and data stored in previous execution database 112 can be used to update module 106.

The context-aware segment retrieval module 116 can include instructions executed (e.g., by a processor) to retrieve particular route segments from database 112 based on the contextual metadata corresponding thereto. For example, a user may have a preference that his/her planned route not include traffic congestion. As such, route segments associated with traffic congestion (e.g., as indicated by contextual metadata corresponding to those route segments) may not be retrieved from database 112, or may be assigned a lower ranking, in association with generating the planned route for the user. As another example, route segments corresponding to deviations from a corresponding route plan may be assigned a higher ranking, based upon an assumption that an error in the planned route resulted in the deviations. Therefore, the context-aware segment retrieval module 116 can be used to filter undesirable route segments, and/or to prefer other route segments, based on their associated contextual metadata.

The previous execution segment retrieval and assembly module 118 includes instructions executable to generate at least a portion of a planned route by assembling a number of route segments (e.g., a number of route segments provided by context-aware segment retrieval module 116). In a number of embodiments, the module 118 can generate multiple planned routes (or at least portions thereof) between a source and destination by assembling a set of previously traversed route segments each corresponding to one or more of a number of previously traversed routes. The routes or segments generated by module 118 can be ranked (e.g., according to user preferences) and, as indicated by arrow 119, can be provided to route segment aggregation module 120. The aggregation module 120 can generate a planned route by aggregating the assembled set of previously traversed route segments (as determined by module 118) and a number of route segments determined by a model-based route planning subsystem (e.g., route segments generated by module 108 of subsystem 102).

In a number of embodiments, a planned route can be generated by route planning system 100 (and provided to a user via user interface 130) without the use of route segment aggregation module 120. That is, a planned route generated solely by the previous execution subsystem 110 (e.g., without aggregating route segments assembled by module 118 and route segments generated by module 108 of model-based subsystem 102) can be provided to a user. Similarly, a planned route generated solely by the model-based subsystem 102 (e.g., without aggregating route segments generated by module 108 and route segments assembled by module 118 of previous execution subsystem 110) can be provided to a user. However, aggregating route segments generated by modules 108 and 118 (e.g., via aggregation module 120) can provide benefits such as possibly providing a user with a more optimal planned route as compared to a route generated solely by one of subsystems 102 and 110. For example, in some instances, previous execution data may not be available for one or more route segments. As such, in a number of embodiments, route segments generated by subsystem 102 can be used to fill in for those route segments for which previous execution data is unavailable (e.g., does not exist). Moreover, it can be beneficial to present a user of system 100 with the option of being provided a route generated solely by subsystem 102, solely by subsystem 108, or based on an aggregation of route segments generated by both subsystems 102 and 110.

Arrow 121 shown in FIG. 1 illustrates route planning information being provided from a user to route segment aggregation module 120. In this example, the information includes a route source, a route destination, and a number of user preferences associated with the route. As described above, the aggregation module 120 can generate one or more planned routes for the user, which can be provided to user interface 130 (e.g., as indicated by arrow 122). In a number of embodiments, aggregation module 120 can also evaluate the one or more planned routes and, as indicated by arrow 122, can provide the user with an analysis and/or critique of the one or more planned routes provided (e.g., displayed) to user interface 130. The analysis/critique can also be displayed to the user. The analysis/critique can correlate with one or more user preferences and can provide the user with, for example, an indication that a planned route passes through an undesirable (e.g., congested or unsafe) area, that the planned route may be scheduled to occur at an undesirable time (e.g., during rush hour, at the time of a sporting event, when a church service is ending, at bar closing time, etc.), that the planned route may not meet time requirements, that the planned route (or one or more segments thereof) is unsuitable for a particular mode of transport, and/or that one or more segments of the planned route has been repeatedly avoided by others (e.g., based on previous execution data stored in database 112), among various other information about a planned route.

Although not explicitly illustrated in FIG. 1, in a number of embodiments, a user can (e.g., via user interface 130) generate a planned route by manually choosing a path between a source and destination. For instance, a map from database 104 can be displayed to user interface 130 and the user can select a number of segments representing a route between the source and destination. In such an example, the route segment aggregation module 120 can evaluate the user generated planned route and provide an analysis/critique of the same.

In a number of embodiments, and as illustrated by arrow 123, a user can (e.g., via user interface 130) make manual adjustments (e.g., edits) to a planned route provided by the aggregation module 120 (e.g., based on the plan critique/analysis or otherwise). For instance, a user may decide to adjust one or more preferences associated with the planned route or may decide to manually adjust one or more of the route segments corresponding to the planned route. As illustrated by arrow 124, one or more adjusted route plans can be provided to user interface 130 (e.g., based on manual plan edits of the user).

In a number of embodiments, the execution of the planned route (e.g., the actual traversal of the planned route) can be monitored. For instance, instructions associated with planning improvement module 126 can be executed to determine whether the route is traversed as planned, or whether the traversing entity (which may be the user interacting with user interface 130 or a different individual being tracked via a separate computing device, for example) deviates from the planned route. In a number of embodiments, certain information can be inferred by system 100 responsive to monitoring of the actual execution of the planned route. For instance, system 100 can infer that a certain point associated with one or more planned routes is undesirable (e.g., dangerous, congested, or blocked) responsive to determining (e.g., detecting) a number of divergences (e.g., deviations) from planned routes at a particular point, for instance. Such information can be used to update contextual metadata associated with system 100 (e.g., metadata 114 and/or 106) via route planning improvement module 126, for example.

Although arrow 125 is shown from user interface 130 to planning improvement module 126, in a number of embodiments, the information corresponding to the actual traversal of the planned route can be provided to module 126 via a different computing device (e.g., a mobile navigation device used by the traversing entity). As an example, the user interface 130 can correspond to a computing device used by a mission planner, and the planned route can be transmitted to a separate computing device of an entity traversing the route as part of mission execution.

In a number of embodiments, monitoring the actual traversal of the planned route can be used for planning future routes. For example, divergence from the planned route can be incorporated into future route planning by system 100 (e.g., such that a user providing the same source, destination, and preferences in the future may not be presented with the same route). As such, the system 100 can, in effect, learn from monitoring planned routes as executed and incorporate the learned information into future planned routes. As indicated by arrow 127, information from planning improvement module 126 can be provided to subsystem 110 (e.g., to update contextual metadata 114 based on the monitored execution of planned routes). Similarly, arrow 129 indicates that information from planning improvement module 126 can be provided to subsystem 102 (e.g., to update informational overlay 106 based on the monitored execution of planned routes). In a number of embodiments, a user can manually provide information to planning improvement module 126 (e.g., via user interface 130). Such information can include context information (e.g., contextual metadata) associated with one or more segments of the planned route (e.g., information regarding reasons why the user did or did not traverse the route as planned, for instance).

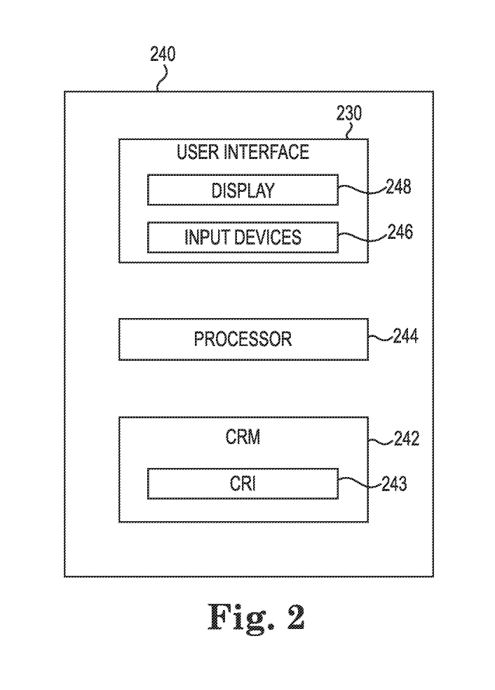

FIG. 2 illustrates a computing device 240 associated with route planning in accordance with a number of embodiments of the present disclosure. The device 240 includes processor resources 244 (e.g., a number of processor and/or coprocessors) configured to execute instructions (e.g., computer readable instructions (CRI) 243) stored on a tangible, non-transitory, computer readable medium (CRM) 242. The computer readable medium 242 can include one or more of volatile memory (e.g., DRAM), non-volatile memory (e.g., Flash memory), digital versatile discs (DVDs), compact discs (CDs), and Blu-ray discs (BDs), among various other types of computer readable media.

In a number of embodiments, and as shown in FIG. 2, device 240 includes a user interface 230, which can be analogous to user interface 130 described in FIG. 1. In this example, the user interface 230 includes a number of input devices 246, such as a keyboard, mouse, and/or memory reader (e.g., optical memory reader, magnetic memory reader, solid state memory reader, etc.), among other input devices. In this example, the user interface 230 includes a display 248, which can be a touch screen display used as an input device. As such, in a number of embodiments, the user interface 230 is in the form of a GUI (graphical user interface). A user (e.g., a user of system 100 shown in FIG. 1) can manually interact with device 240 via the user interface 230.

The computer readable instructions 243 can include various sets of instructions in the form of application and/or program modules (e.g., software), which can be executed by processor resources 244 in association with performing various route planning embodiments as described herein. As an example, the instructions 243 can include instructions (e.g., instructions corresponding to aggregation module 120) that are executed to generate a planned route and provide the planned route to user interface 230 (e.g., to display 248) in association with embodiments described herein. In various embodiments, portions of subsystems such as subsystems 102 and 110 shown in FIG. 1 can be stored in memory corresponding to CRM 242 (e.g., as CRI 243).

FIG. 3 illustrates a functional flow diagram associated with generating a planned route based on previous execution data in accordance with a number of embodiments of the present disclosure. The embodiment shown in FIG. 3 illustrates an example of previous execution data associated with a previous execution database 312. Database 312 can be a previous execution database such as that described above in connection with FIG. 1. The database 312 can store data corresponding to a number of previously planned routes (e.g., previously planned routes between a source and destination), as well as previous execution data corresponding to actual traversals of the previously planned routes. Embodiments are not limited to the example shown in FIG. 3. For instance, in a number of embodiments, the database 312 may include previous execution data corresponding to previously executed routes, and data associated with previous route plans to which the previous execution data corresponds, may be included elsewhere (e.g., in a contextual metadata module such as module 114 shown in FIG. 1.) In the example illustrated in FIG. 3, the previous execution database 312 includes data corresponding to previously traversed planned routes 351-1 (PTR_1), 351-2 (PTR_2), 351-3 (PTR_3), . . . , 351-N (PTR_N).

As shown in FIG. 3, previously traversed route 351-1 represents a previously planned route from location A (e.g., source) to location B (e.g., destination), previously traversed route 351-2 represents a previously planned route from location C to location D, previously traversed route 351-3 represents a previously planned route from location A to location D, and previously traversed route 351-N represents a previously planned route from location A to location B. Each of the previously traversed routes 351-1, 351-2, 351-3, . . . , 351-N includes respective contextual metadata 352-1, 352-2, 352-3, . . . , 352-N (shown as “Context Data” in FIG. 3) corresponding thereto. The contextual metadata 352-1, 352-2, 352-3, . . . , 352-N can include contextual data associated with the time of day a previously planned route was traversed, particular topography of the route, local weather patterns when the route was traversed, mode(s) of transport, a number of times a previously planned route has been traversed, how many times the previously planned route has been traversed recently (e.g., within a given time period such as a day, week, month, year, etc.), and/or metadata corresponding to weightings of the contextual data (e.g., which may be used for ranking segments of a planned route), among various other contextual data corresponding to the previously traversed routes 351-1, 351-2, 351-3, . . . , 351-N.

As illustrated in FIG. 3, previous execution database 312 can include previous execution data corresponding to different previously planned routes having a common source and destination. For instance, both previously traversed route 351-1 and 351-N represent previous traversals of previously planned routes between location A and B. In various instances, the previous execution database 312 includes previous execution data corresponding to different previously planned routes having only one of the source and destination in common. For instance, previously traversed routes 351-2 and 351-3 share a common destination (e.g., location D), but not a common source. In a number of embodiments, the database 312 can include previous execution data corresponding to multiple different traversals of a same previously planned route. In such instances, the context data corresponding to the respective different traversals may or may not be different. Embodiments are not limited to the examples illustrated in FIG. 3.

In a number of embodiments, the previous execution data associated with the previously traversed routes 351-1, 351-2, 351-3, . . . , 351-N can be segmented. As such, database 312 can include previous execution data corresponding to segments of previously planned routes. For example, previous execution data corresponding to previously traversed routes 351-1, 351-2, 351-3, . . . , 351-N can be segmented based on intersections between the previously traversed routes and/or based on divergences between the previously traversed routes.

In the example shown in FIG. 3, previously traversed route 351-1 is segmented into route segments 355-1 (S_1), 355-2 (S_2), and 355-3 (S_3). Previously traversed route 351-2 is segmented into route segments 356-1 (S_4), 356-2 (S_5), and 356-3 (S_6). Previously traversed route 351-3 is segmented into route segments 357-1 (S_7), 357-2 (S_2), and 357-3 (S_6). Also, previously traversed route 351-N is segmented into route segments 358-1 (S_8), 358-2 (S_9), and 358-3 (S_10). As shown in FIG. 3, in a number of embodiments, different previously traversed planned routes may include one or more of the same route segments corresponding thereto (e.g., they may share common route segments). For instance, previously traversed routes 351-1 and 351-3 have route segment S_2 in common. Similarly, previously traversed routes 351-2 and 351-3 have route segment S_6 in common.

As shown in FIG. 3, each of the route segments 355-1, 355-2, 355-3, 356-1, 356-2, 356-3, 357-1, 357-2, 357-3, 358-1, 358-2, and 358-3, includes respective contextual metadata 359-1, 359-2, 359-3, 360-1, 360-2, 360-3, 361-1, 361-2, 361-3, 362-1, 362-2, and 362-3 corresponding thereto (shown as “CD” in FIG. 3). The contextual metadata 359-1, 359-2, 359-3 can be subsets of contextual metadata 352-1, the contextual metadata 360-1, 360-2, 360-3 can be subsets of contextual metadata 352-2, the contextual metadata 361-1, 361-2, 361-3 can be subsets of contextual metadata 352-3, and the contextual metadata 362-1, 362-2, 362-3 can be subsets of contextual metadata 352-N.

In various embodiments, route segments from database 312 can be retrieved based on their corresponding context data (e.g., via context-aware retrieval module 116 shown in FIG. 1) and sets of route segments can be assembled (e.g., via previous execution segment retrieval and assembly module 118 shown in FIG. 1) to generate (e.g., form) at least a portion of a planned route between source and destination based on particular user preferences. As shown in FIG. 3, in various embodiments, a ranked route list 364 including an assembled number of routes (or route segments) can be generated (e.g., based on contextual metadata corresponding to the respective route segments and associated with particular user preferences).

In this example, the ranked route list 364 includes three ranked routes (RRs) 366-1 (RR_1), 366-2 (RR_2), and 366-3 (RR_3), although embodiments are not limited to a particular number of routes provided to a user in the form of a ranked list of routes. The ranked route 366-1 includes assembled route segments (S_1, S_2, and S5), the ranked route 366-2 includes assembled route segments (S_1, S_2, and S_6), and the ranked route 366-3 includes assembled route segments (S_8, S_9, and S_6). The assembled routes 366-1, 366-2, and 366-3 can be listed in a variety of manners. For example, a “best” route (e.g., optimal) of the assembled routes 366-1, 366-2, and 366-3 of list 364 may be listed first. As another example, the ranked list 364 may be organized such that each of the assembled routes represents a “best” route based on maximizing a particular user preference, for instance.

As described above, in various embodiments, the assembled routes (which can represent at least a portion of a planned route) can be aggregated with one or more route segments provided by a model-based route planning subsystem (e.g., subsystem 102 shown in FIG. 1) and/or can be provided to a user interface (e.g., user interface 130 shown in FIG. 2 or user interface 230 shown in FIG. 2) such that the generated planned route(s) are displayed to a user.

As an example, one or more of the assembled routes 366-1, 366-2, and 366-3 may not represent a complete planned route between a particular source and destination. In such instances, a complete planned route between the source and destination can be generated by aggregating the assembled route segments corresponding to previously executed route segments and one or more route segments provided by a model-based route planning subsystem.

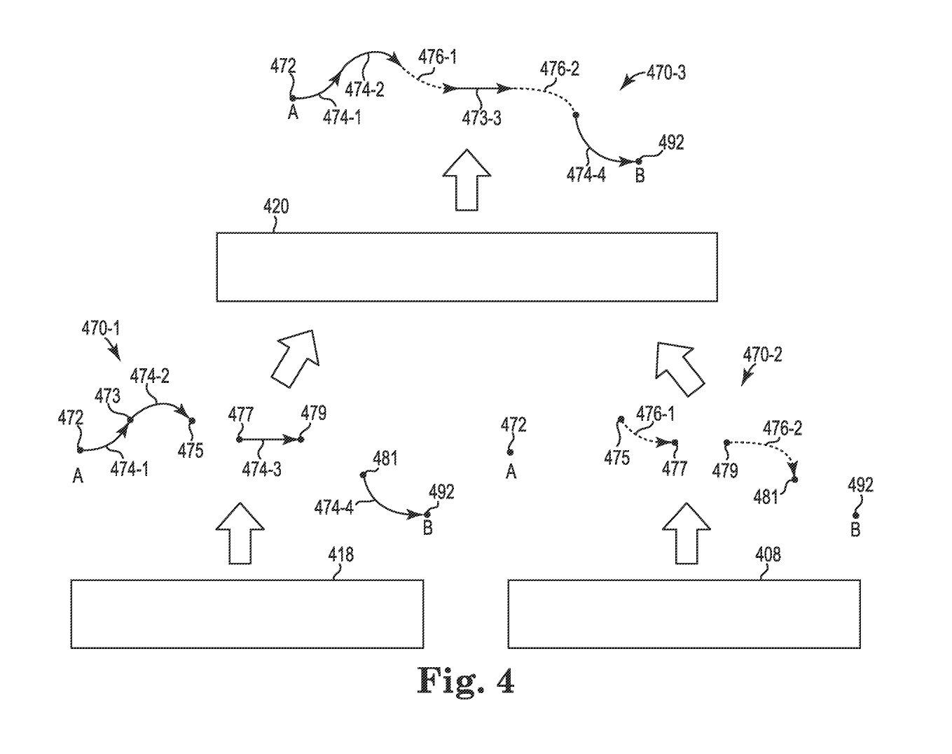

FIG. 4 illustrates a functional flow diagram associated with generating a planned route in accordance with a number of embodiments of the present disclosure. The example illustrated in FIG. 4 includes a previous execution segment retrieval and assembly module 418, a model-based planning module 408, and a route segment aggregation module 420, which can be analogous to respective modules 118, 108, and 120 described above in connection with FIG. 1.

The example shown in FIG. 4 includes a first portion 470-1 of a planned route between a first location 472 (e.g., a source location “A”) and a second location 492 (e.g., a destination location “B”), a second portion 470-2 of the planned route between locations 472 and 492, and a complete planned route 470-3 between locations 472 and 492. As illustrated, the portion 470-1 is generated by the previous execution module 418, the portion 470-2 is generated by the model-based planning module 408, and the complete route 470-3 is generated by the aggregation module 420.

The first portion 470-1 of the planned route between locations 472 and 492 comprises a set of previously traversed route segments 474-1, 474-2, 474-3, and 474-4. Route segment 474-1 spans from location 472 to location 473, route segment 474-2 spans from location 473 to location 475, route segment 474-3 spans from location 477 to location 479, and route segment 474-4 spans from location 481 to location 492. The previously traversed route segments 474-1, 474-2, 474-3, and 474-4 can each correspond to one or more of a number of previously traversed routes, which may or may not be routes from location 472 to location 492, for instance.

As illustrated in the example of FIG. 4, the previous execution module 418 does not generate route segments between locations 475 and 477 or between locations 479 and 481. As such, the portion 470-1 of the planned route between source A and destination B does not include route segments between those locations. The missing route segments associated with portion 470-1 can correspond to areas for which previous execution data does not exist, for instance. That is, previous execution module 418 does not have access to sufficient previous execution data to generate route segments between locations 475 and 477 or between locations 479 and 481.

In a number of embodiments, and as illustrated in FIG. 4, a model-based planning module (e.g., 408) can be used to determine route segments between locations for which previous execution data does not exist. In this example, model-based planning module 408 determines a route segment 476-1 between locations 475 and 477 and a route segment 476-2 between locations 479 and 481. As described above, route segments (e.g., 476-1 and 476-2) determined by model-based modules (e.g., 408) can be generated based on cost analysis (e.g., the route segments can be cost-minimal route segments), for instance.

In a number of embodiments, and as illustrated in FIG. 4, a set of previously traversed route segments (e.g., 474-1, 474-2, 474-3, and 474-4) can be aggregated with a number of route segments (e.g., 476-1 and 476-2) determined by a model-based route planning subsystem (e.g., module 408) via an aggregation module (e.g., 420). For instance, the example illustrated in FIG. 4 includes a completed planned route 470-3 between source location 472 and destination location 492, which comprises the set of previously traversed route segments 474-1, 474-2, 474-3, and 474-4 and the model-based route segments 476-1 and 476-2.

As described herein, in a number of embodiments, a planned route such as route 470-3 can be displayed on a computing device and/or can be evaluated based on stored previous execution data corresponding to one or more of the previously traversed route segments 474-1, 474-2, 474-3, and 474-4 and/or based on stored map data corresponding to one or more of the model-based route segments 476-1 and 476-2.

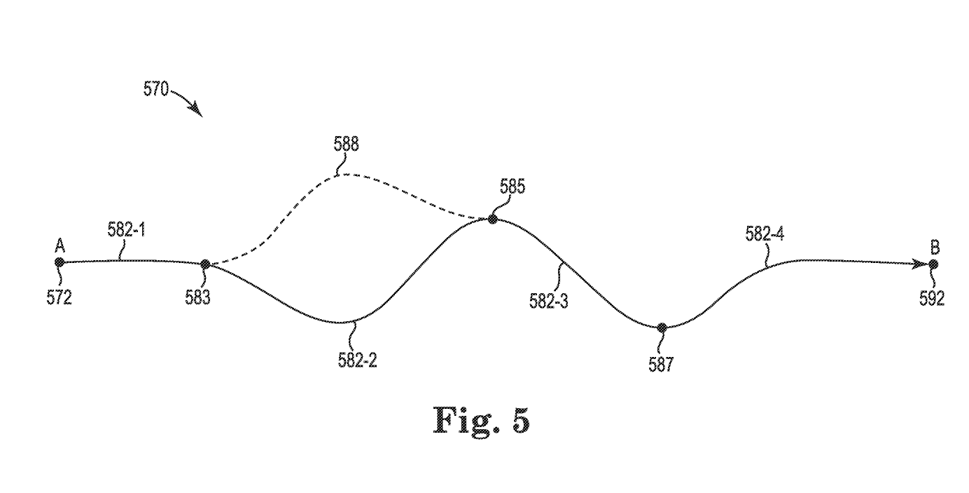

FIG. 5 illustrates a diagram associated with route planning in accordance with a number of embodiments of the present disclosure. FIG. 5 includes a planned route 570 between a first location 572 (e.g., a source location “A”) and a second location 592 (e.g., a destination location “B”). The planned route comprises a number of route segments 582-1, 582-2, 582-3, and 582-4. Route segment 582-1 spans from location 572 to location 583, route segment 582-2 spans from location 583 to location 585, route segment 582-3 spans from location 585 to location 587, and route segment 582-4 spans from location 587 to location 592.

The planned route 570 can comprise a number of previously traversed route segments (e.g., segments 474-1, 474-2, 474-3, and 474-4 shown in FIG. 4) aggregated with a number of model-based route segments (e.g., 476-1 and 476-2 shown in FIG. 4). As described above in connection with FIG. 1, for example, a number of embodiments can include tracking an actual traversal of the planned route 570 (e.g., by a traversing entity). For instance, in the example illustrated in FIG. 4, the dashed arrow corresponds to a deviation 588 from the as-planned route 570. The deviation 588 can represent an alternate path (e.g., a path deviating from the as-planned route 570) taken during an actual traversal of the as-planned route 570. A deviation (e.g., 588) from an as-planned route (e.g., 570) may occur for a variety of reasons. For example, a path corresponding to route segment 582-2 may be undesirable (e.g., due to traffic backup) or impassable (e.g., due to construction).

In a number of embodiments, information corresponding to the as-planned route segment 582-2 can be inferred based on the tracking of the actual traversal of route 570. For instance, it may be inferred that traversing segment 582-2 is undesirable based on the fact that the actual traversal of the route 570 involved deviation 588. This information can be inferred regardless of whether a route planning system is aware (or is made aware) of the actual reason for the deviation 588 from the as-planned route 570 and can be used in future route planning. For instance, a future planned route may comprise a path other than segment 582-2 between locations 583 and 585 (e.g., based on an inference that segment 582-2 is undesirable).

As an example, information associated with a previous execution subsystem such as subsystem 110 described in FIG. 1 (e.g., contextual metadata 114) and/or information associated with a model-based subsystem such as subsystem 102 described in FIG. 1 (e.g., information overlay 106) can be updated based on the information inferred due to deviation 588. For instance, a planning improvement module (e.g., module 126 shown in FIG. 1) can be used to update such information.

### CONCLUSION

The present disclosure includes systems and methods for route planning. As an example, a computer implemented method for route planning can include generating a planned route between a first location and a second location. The planned route comprises a number of route segments and the method can include evaluating the planned route using stored previous execution data associated with a number of previously executed traversals of at least one of the number of route segments.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one.

Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer implemented method for route planning, the method comprising:
generating a first portion of a planned route between a first location and a second location by assembling a set of previously traversed route segments each corresponding to one or more of a number of previously traversed routes;
aggregating the set of previously traversed route segments with a number of route segments determined by a model-based route planning subsystem and corresponding to a second portion of the planned route; and
causing the planned route to be provided to a display of a computing device.

2. The method of claim 1, wherein the previously traversed route segments are defined based on at least one of:
points of intersection of the number of previously traversed routes; and
points of divergence of the number of previously traversed routes.

3. The method of claim 1, further comprising evaluating the planned route using at least one of:
stored previous execution data corresponding to a number of previously executed traversals of at least one of the number of previously traversed route segments of the set; and
stored map data associated with the model-based route planning subsystem.

4. The method of claim 3, wherein the stored previous execution data includes metadata indicating a number of times particular route segments have been traversed within a particular time period.

5. The method of claim 3, further comprising providing, to the display of the computing device, analysis information based on the evaluating of the planned route.

6. The method of claim 5, further comprising:
evaluating an adjusted route using stored data associated with a number of previously executed traversals of at least one route segment of the adjusted route, the adjusted route representing a modification to the planned route made by a user via a user interface of the computing device; and
providing, to the display of the computing device, analysis information based on the evaluating of the adjusted route.

7. A computer readable medium having instructions stored thereon that are executed by a processor to:
generate a planned route between a first location and a second location, the planned route comprising a number of route segments, wherein the number of route segments include:
a set of previously traversed route segments each corresponding to one or more of a number of previously traversed routes; and
a number of model-based route segments aggregated with the set of previously traversed route segments; and
evaluate the planned route based on:
stored previous execution data corresponding to a number of previously executed traversals of at least one of the number of previously traversed route segments of the set; and
stored map data corresponding to at least one of the number of model-based route segments.

8. The computer readable medium of claim 7, including instructions executed to retrieve the previously traversed route segments of the set from a database storing previous execution data corresponding to the number of previously traversed route segments of the set as well as previous execution data corresponding to previously traversed route segments other than those of the set.

9. The computer readable medium of claim 8, including instructions executed to provide updated execution data corresponding to the respective previously traversed route segments of the set based on a monitoring of an actual traversal of the planned route.

10. The computer readable medium of claim 7, including instructions executed to select the previously traversed route segments of the set based on contextual metadata corresponding to the previously traversed route segments of the set and stored along with previous execution data corresponding to the previously traversed route segments.

11. The computer readable medium of claim 7, wherein the one or more of the number of previously traversed routes includes at least one previously traversed route between the first location and the second location.

12. The computer readable medium of claim 7, including instructions executed to display the planned route to a graphical user interface.

13. The computer readable medium of claim 12, including instructions executed to provide analysis information associated with the generated planned route to the graphical user interface based on evaluation of the generated planned route.

14. The computer readable medium of claim 13, wherein the analysis information includes an indication that at least one of the number of route segments was avoided in association with a traversal of a previously planned route.

15. The computer readable medium of claim 12, including instructions executed to display an adjusted route to the graphical user interface, the adjusted route representing a modification to the generated planned route made by a user via the graphical user interface.

16. A system for route planning, comprising:
a computing device including processor and memory resources and a user interface, the user interface configured to receive user input corresponding to a source, a destination, and a number of user preferences associated with a route to be planned;
a previous execution subsystem including:
a previous execution database; and
an assembly module configured to assemble a set of previously traversed route segments stored in the previous execution database and representing at least a first portion of a planned route between the source and destination;
a model-based subsystem including:
a map database; and
a map-based planning module configured to determine a number of route segments based on information stored in the map database and corresponding to at least a second portion of the planned route; and
an aggregation module configured to:
generate a complete planned route between the source and destination by aggregating one or more previously traversed route segments of the set assembled by the assembly module and representing the at least a first portion of the planned route and one or more of the number of route segments determined by the map-based planning module and corresponding to the at least a second portion of the planned route.

17. The system of claim 16, wherein the previously traversed route segments stored in the previous execution database are defined based on at least one of:
points of intersection of the number of previously traversed routes; and
points of divergence of the number of previously traversed routes.

18. The system of claim 16, further comprising a module configured to:
track an actual traversal of the complete planned route;
infer information corresponding to one or more segments of the complete planned route based on the tracking; and
update contextual metadata stored in the previous execution database and corresponding to the one or more segments of the complete planned route based on the inferred information.

19. The system of claim 16, wherein the system is configured to:
display the complete planned route to a display of the computing device;
display an analysis of the complete planned route to the computing device;
allow a user of the computing device to make a number of modifications to the complete planned route via the user interface; and
generate an adjusted complete planned route for the user based on the number of modifications.

20. The system of claim 19, wherein the system is configured to update at least one of the map database and the previous execution database responsive to the number of modifications to the complete planned route.
